(19) United States
(12) Patent Application Publication
(10) Pub. No.: US 2024/0304897 A1
(43) Pub. Date: Sep. 12, 2024

(54) DIRECT HYDROSTATIC COMPRESSION SYSTEM FOR BATTERY MODULES OF AN ELECTRIC VEHICLE

(71) Applicant: FCA US LLC, Auburn Hills, MI (US)

(72) Inventors: Oliver Gross, Oxford, MI (US); Daniel E. Hornback, Davisburg, MI (US); Tae Hyun Kim, Troy, MI (US)

(21) Appl. No.: 18/178,907

(22) Filed: Mar. 6, 2023

(51) Int. Cl. H01M 10/6568; H01M 10/48

(52) U.S. Cl. CPC H01M 10/6568; H01M 10/486

(57) ABSTRACT

A battery module compression system includes a battery module having a first end wall spaced apart from a second end wall. Battery cells are disposed between the first and second end walls. A fluid path is between the plurality of battery cells and the walls. An inlet valve is in fluid communication with an inlet module pump communicating dielectric fluid into the battery module into the fluid path between the battery cells and the walls. A pressure sensor generates a pressure signal indicative of the pressure within the battery module. A temperature sensor generates a temperature signal indicative of the temperature within the battery module. A controller is coupled to the inlet module pump, the inlet valve and an outlet valve to independently control a flow rate into the battery module and the pressure within the battery module based on the temperature signal, and the pressure signal.

### FIELD

The present disclosure relates to a battery module system and, more particularly, to an immersive cooling environment with controlled pressure and temperature control.

### BACKGROUND

This section provides background information related to the present disclosure which is not necessarily prior art.

Electric vehicles rely on battery cells bundled into one or more battery modules to power the vehicle. The battery cells increase the temperature and pressure inside the battery module housing during use. As long as the temperature and pressure-build up remain within a tolerable range, the battery cells can continue to operate. To operate efficiently, the temperature and pressure across the battery modules should be operated within a very close range.

Cell technology is ever-changing. Newer technologies beyond lithium ion change over the course of their life. For example, some newer cell technologies swell and contract during cycling. New cells may also change dimensions during their life.

In order to monitor the status of battery cells and/or a battery module, electric vehicle power systems may include temperature sensors to monitor temperatures associated with the battery modules and/or battery cells. Such systems are typically used to detect runaway conditions in a battery module.

### SUMMARY

This section provides a general summary of the disclosure and is not a comprehensive disclosure of its full scope or all of its features.

The present disclosure provides a system that provides independent control of flow rate and pressure within a battery module to provide controlled pressurization and temperature control within the battery module to accommodate swelling and contraction of the battery cells during operation.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a battery module having a plurality of walls, said plurality of walls may include a first end wall spaced apart from a second end wall, said first end wall may include a fluid inlet and the second end wall may include a fluid outlet; a plurality of battery cells disposed between the first end wall and the second end wall, a fluid path is disposed between the plurality of battery cells and the plurality of walls; an inlet module pump; an inlet valve in fluid communication with the inlet module pump communicating dielectric fluid into the battery module into the fluid path the battery cells and the plurality of walls; an outlet valve in fluid communication with the outlet; a pressure sensor generating a pressure signal indicative of the pressure within the battery module; a temperature sensor generating a temperature signal indicative of the temperature within the battery module. The system also includes a controller coupled to the inlet module pump, the inlet valve and the outlet valve, said controller independently controlling a flow rate into the battery module and the pressure within the battery module, said controller controlling the inlet module pump to control the flow rate based on the temperature signal and the inlet valve and the outlet valve to control the pressure based on the pressure signal. Other embodiments of this aspect include corresponding computer systems, apparatus, and computer programs recorded on one or more computer storage devices, each configured to perform the actions of the methods.

Implementations may include one or more of the following features. The system where the fluid path may include a first fluid path and a second fluid path. The system may include a first baffle on an inlet side of the battery module arresting fluid flow in the first fluid path and the second fluid path toward the outlet. The first baffle may include openings for obtaining a predetermined pressure within the battery module. The system may include a second baffle disposed on an outlet side of the battery module arresting fluid flow in the first fluid path and the second fluid path toward the outlet. The system wherein the second baffle may include openings for obtaining a predetermined pressure within the battery module. The pressure sensor is disposed in the fluid path and the pressure signal corresponds to a pressure within the fluid path. The inlet module pump may include a constant flow rate pump and a differential flow rate pump, said differential flow rate pump selectively controlled by the controller. The outlet is fluidically coupled to a heat exchanger. The system may include an expansion element disposed between the outlet valve and the heat exchanger. The plurality of battery cells may include spacers therebetween. Implementations of the described techniques may include hardware, a method or process, or computer software on a computer-accessible medium.

One general aspect includes a method of controlling a battery module having a plurality of walls. The method also includes communicating dielectric fluid into fluid paths between the battery cells and module wall from outside the battery module with an inlet module pump through an inlet valve. The method also includes communicating the dielectric fluid from the battery module through an outlet valve. The method also includes controlling a pressure within the battery module based on a pressure signal from within the battery module by controlling the inlet valve and the outlet valve. The method also includes controlling a temperature within the battery module by controlling a flow rate through the battery module by controlling the inlet module pump. Other embodiments of this aspect include corresponding computer systems, apparatus, and computer programs recorded on one or more computer storage devices, each configured to perform the actions of the methods.

Implementations may include one or more of the following features. The method may include generating the pressure signal from a pressure sensor disposed within one of the fluid paths. The method may include arresting flow of dielectric fluid from the inlet toward the outlet by using a first baffle. The method may include sizing openings in the first baffle to obtain a predetermined module pressure. The method may include arresting flow of dielectric fluid from the inlet toward the outlet by using a second baffle. The method may include sizing openings in the first baffle to obtain a predetermined module pressure. Controlling the pressure may include controlling the pressure may include maintaining the pressure by closing the inlet valve and the outlet valve and stopping the inlet module pump. The method may include communicating dielectric fluid to an expansion element after the outlet valve. Implementations of the described techniques may include hardware, a method or process, or computer software on a computer-accessible medium.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagrammatic view of a high voltage battery within a vehicle.

FIG. 2A is an example of a battery module within the high voltage battery of FIG. 1 as controlled by the battery conditioning system and the battery management system.

FIG. 2B is a diagrammatic view of a battery module having baffles.

FIG. 2C is a diagrammatic view of a high voltage battery having a plurality of battery modules.

FIG. 2D is an example of a battery module having multiple stacks of battery cells.

FIG. 3 is a flowchart of a method for operating the battery management system to control the pressure within the battery module.

Corresponding reference numerals indicate corresponding parts throughout the several views of the drawings.

### DETAILED DESCRIPTION

Example embodiments will now be described more fully with reference to the accompanying drawings.

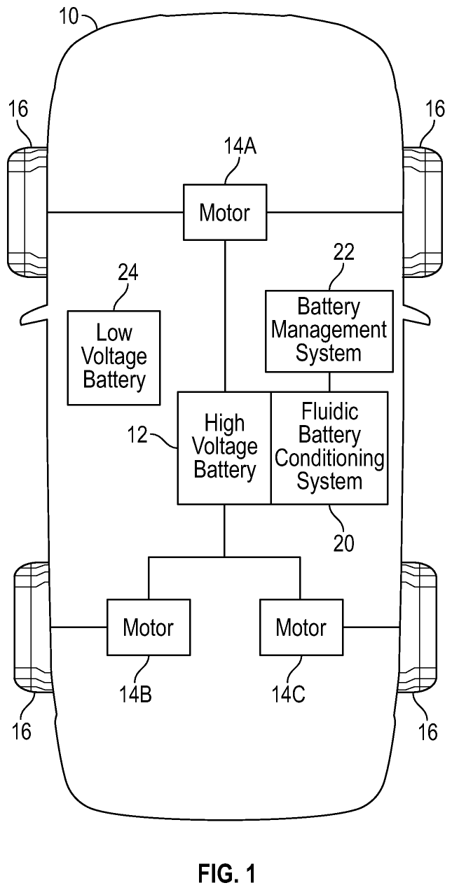

Referring now to FIG. 1, a schematic block diagram of a vehicle 10 is illustrated. The vehicle 10 is adapted to include various features not illustrated such as a passenger compartment mounted thereon.

The vehicle 10 is an electric vehicle that has a high voltage battery 12 that is used to power one or more electric motors 14A, 14B and 14C. The electric motors 14A, 14C, 14C are used to provide motive force to the vehicle wheels 16. The number of motors within an electric vehicle may vary. Each of the wheels 16 may have their own motor associated therewith. As shown in the rear of the vehicle 10, each wheel has an electric motor 14B, 14C. One motor 14A is used to power the wheels at one end of the vehicle. The motors 14B and 14C power individual wheels 16.

A fluidic battery conditioning system 20 is used for controlling the temperature and pressure within the high voltage battery 12. A battery management system 22, in communication with the fluidic battery conditioning system and any sensors associated with the high voltage battery, is used to control the operation of the fluidic battery conditioning system 20 as described in more detail below. The battery management system 22 is a microprocessor-based controller programmed to perform various steps sed in the operation of the system.

The vehicle 10 also includes a low voltage battery 24 that has a voltage less than the high voltage battery 12. Examples for the low voltage battery 24 include but are not limited to a 12 volt or 48 volt battery. An example of a high voltage battery 12 is 400 volts plus or minus 50 volts.

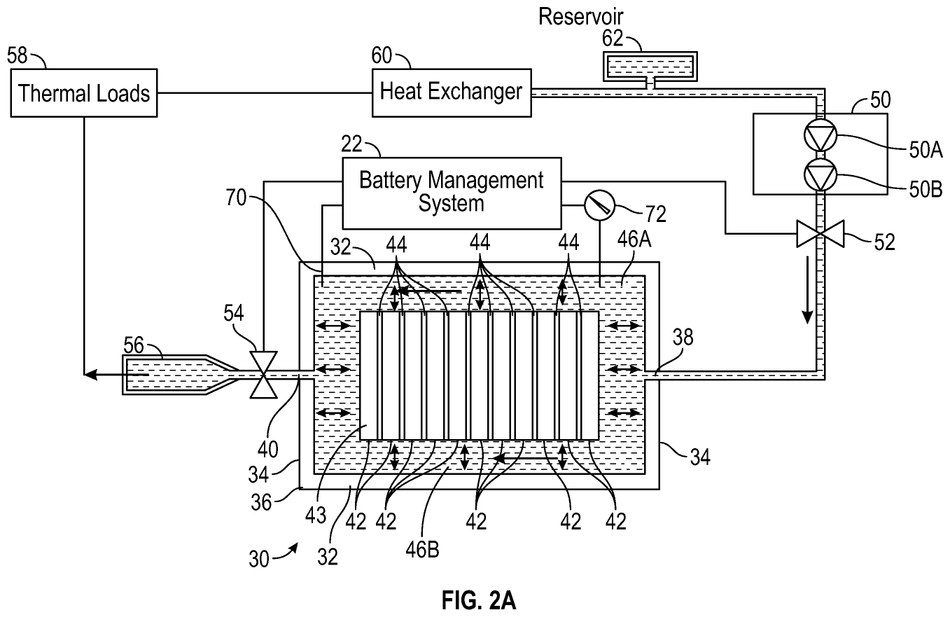

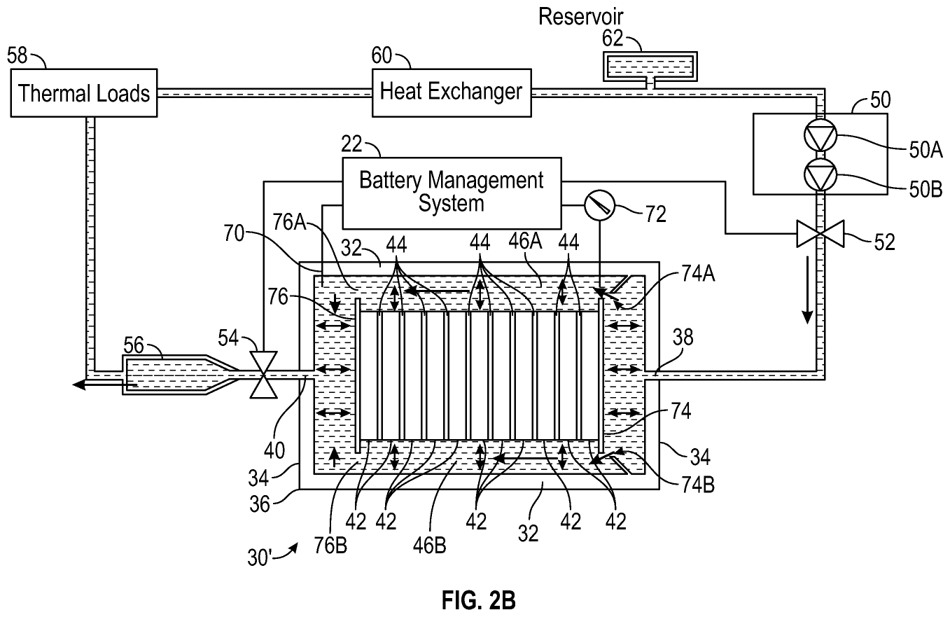

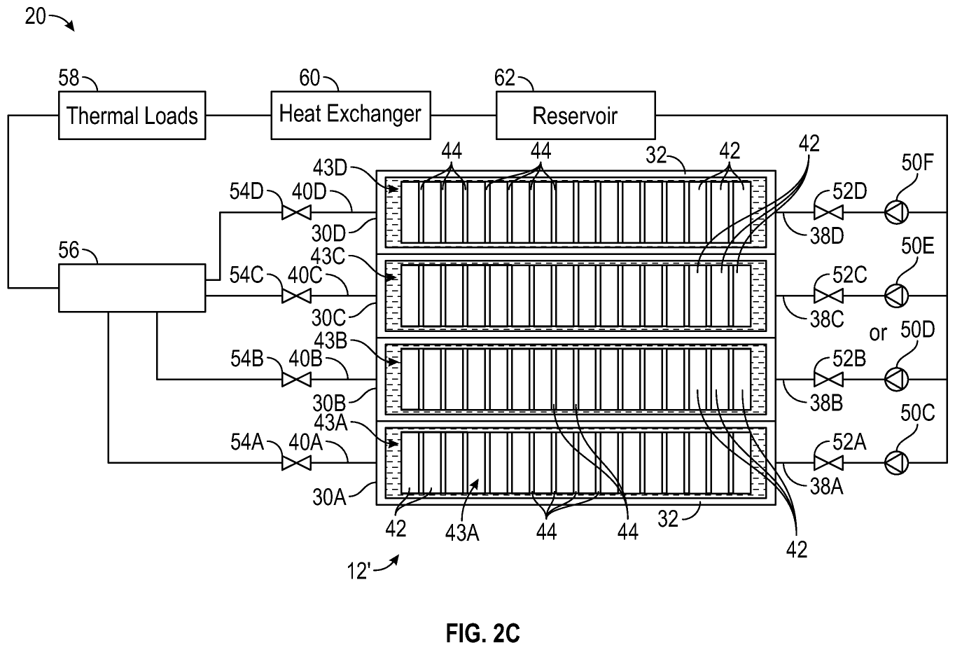

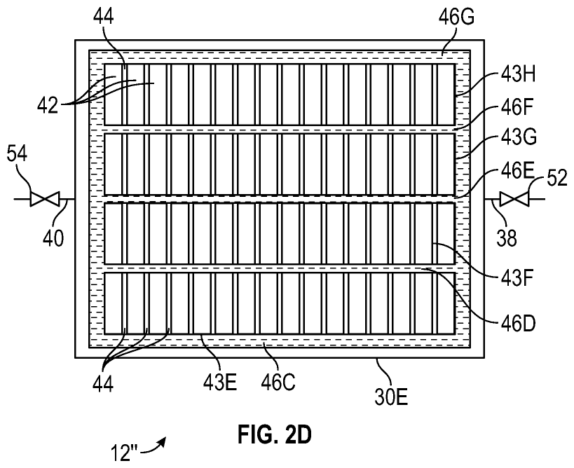

Referring now to FIG. 2A, a battery module 30 representing one battery module of a plurality of battery modules 30 provided within the high voltage battery 12 is illustrated in FIG. 1. The battery module 30 is formed from longitudinal sides 32, which in this example are parallel. End walls 34 are parallel and coupled to the longitudinal sides 32. In the present example, the longitudinal sides 32 and the end walls 34 (and a cover wall and floor wall, not shown) form a rectangular solid that forms a housing 36. At least one of the longitudinal sides 32, the end walls 34, the cover or the floor of the housing 36 have a fluid inlet 38 and a fluid outlet 40 so that dielectric fluid is passed into and out of the housing 36. In this example, the end walls 34 have the inlet 38 and the outlet 40. A plurality of battery cells 42 are disposed within the housing 36. The battery cells 42, in this example, are parallel to the end walls 34 and perpendicular to the longitudinal walls 32. Of course, other configurations are available. Spacers 44 are disposed between the battery cells 42. The spacers 44 are formed of foam in this example. The spacers 44 are therefore compressible.

The battery cells 42 are positioned within the housing so that a first fluid path 46A and a second fluid path 46B allow the dielectric fluid to flow from the inlet 38 to the outlet 40.

The fluidic battery conditioning system 20 of FIG. 1 includes an inlet module pump 50 that communicates the dielectric fluid into the inlet 38 and around the battery cells 42 and through the fluid paths 46A, 46B within the housing 36. The inlet module pump 50 has, in this example, shows two separate pumps 50A and 50B. The pump 50A is a constant flow rate pump. The pump 50B is a differential flow rate pump. The pumps 50A and 50B may use different technologies, for example, the pump 50A is a centrifugal pump. An example of a pump 50B is positive displacement pump. In this manner, a highly efficient constant flow rate pump may be used continuously while a less efficient differential flow rate pump may be used as needed. The inlet module pump 50 is used to control the temperature within the battery module 30 as described in further detail below. Positive displacement pumps (like gear pumps, screw pumps, rotary vane, etc.) are good at providing constant flow rate regardless of discharge pressure. The positive displacement pump is a “hydraulic” pump that delivers the fluid at the pressure needed to hold the compression on the battery cells. The positive displacement pump is good at supplying pressure but not flow for heat transfer. Centrifugal pumps are good at providing lots of flow at relatively low power consumption, but they're super sensitive to discharge pressure. The centrifugal pump is used as a flow pump to deliver the flow rate needed for heat transfer within the battery cells. Although a series combination of pumps is implied, various configurations can be used depending on the physical properties of the pumps used.

An inlet valve 52 allows hydrostatic control of the dielectric fluid in the battery housing 36. That is, the inlet valve 52 is controlled by the battery management system 22 so that the pressure within the housing 36 is controlled as will be described in further detail below.

After the dielectric fluid is communicated to the fluid paths 46A, 46B and the housing 36, the dielectric fluid is communicated through the outlet 40 fluid though an outlet valve 54. Together with the inlet valve 52, the outlet valve 54 is used to control the pressure within the housing 36. The pressure in the battery module 30 may be varied based on swelling of the battery cells 42. The outlet valve 54 may be referred to as a backflow valve.

After the outlet valve 54, the dielectric fluid is fluidically communicated to an expansion element 56 and ultimately is fluidically to the other elements of the fluidic battery conditioning system. The expansion element 56 may be an expansion line or an orifice. The expansion element 56 is used to expand the fluid and therefore reduce the dielectric fluid pressure before being communicated to the cooling components. In one example, the pressure of the dielectric fluid is reduced from about 4 MPa to 0.4 MPa.

After the expansion element 56, dielectric fluid is fluidically communicated to other thermal loads 58 and the heat exchanger 60 to cool the dielectric fluid before the heat exchanger 60 communicates the dielectric fluid to a reservoir 62 and to the inlet module pump 50. The thermal loads 58 and the reservoir 62 are optional features.

It is desirable to compress the plurality of battery cells 42. The battery cells 42 are referred to as a stack 43. Because the housing 36 is sealed, a minimal amount of pressure is provided at the housing 36 in known systems. For example, 0.4 bar is typically provided. However, a significantly greater amount of pressure for the battery cells 42 is desirable under certain conditions for various types of battery cells. For example, more than three bars of pressure may be desired for operating. Pre-compression stack systems are susceptible to a larger fluctuation in pressure during operation.

A temperature sensor 70 generates a temperature signal that corresponds to the temperature of the dielectric fluid within the fluid paths 46A, 46B. The temperature sensor 70 thus provides data that corresponds to the temperature of the battery cells 42. The battery management system 22 increases or decreases the speed of the pump 50 and correspondingly the flow rate based upon the temperature as determined from the temperature signal of the temperature sensor 70. The pump 50 is used to control the flow rate through the housing 36. When one pump is used, the speed of the pump 50 controls the flow rate. As mentioned above, a differential pump 50B may be used to change the flow rate beyond the constant flow rate provided by the pump 50A.

A pressure sensor 72 generates a pressure signal having pressure data that corresponds to the pressure of the dielectric fluid within the housing 36. Based on the pressure indicated by the pressure sensor 72, the battery management system 22 controls the operation of one or both of the valves 52, 54.

Although only one battery module 30 is illustrated, a number of battery modules are provided in a vehicle system that are configured in a similar way in examples below.

Referring now to FIG. 2B, another example of a battery module 30′ is illustrated. In this example, an inlet baffle 74 is used to arrest the fluid flow on the inlet side of the module so that the battery cells 42 are loaded to a predetermined module pressure. By sizing openings 74A and 74B, fluid is restricted in flowing into the fluid paths 46A and 46B. Fluid pressure is thus built up between the baffle 74 and end wall 34 adjacent to the inlet 38.

An outlet baffle 76 is disposed adjacent to the battery cells 42 to restrict the flow of dielectric fluid to the outlet 40. Openings 76A and 76B restrict the fluid flow and the fluid paths 46A and 46B. The baffles 74 and 76 together compress the stack 43 of battery cells 42 to a desired pressure. The size of the openings 74A, 74B, 76A and 76B our size to obtain the predetermined module pressure.

Referring now to FIG. 2C, another example of a high voltage battery 12′ is set forth. The high voltage battery 12′ includes a plurality of battery modules 30A, 30B, 30C, 30D that are positioned adjacent to each other. Some of the battery modules 30A-D may include some common walls. Each of the battery modules 30A-D include respective inlets 38A-D and outlets 40A-D. Each of the battery modules 30A-D include respective battery stacks 43A-43D as described above.

Each of the battery modules 30A-D is coupled to the fluidic battery conditioning system 20 as described in FIGS. 2A and 2B. Each of the battery modules 30A-D includes an outlet valve 54A-54D respectively. However, common elements such as the expansion element 56, the thermal loads 58, the heat exchanger 60, and the reservoir 62 are shared by the battery modules 30A-30D. Each of the battery modules 30A-30D include respective inlet module pumps 50A-50D. In this manner, individual control of the battery modules 30A-30D is achieved.

Referring now to FIG. 2D, another example of high voltage battery 12″ with a battery module 30E is set forth. Battery module 30E has a plurality of stacks 43E-H therein. The battery stacks 43E-H are positioned in parallel and provide respective fluid paths 46C-G therebetween. In this example, only one inlet 38 and one inlet valve 52 and one outlet 40 with one outlet valve 54 is provided for the battery module 30E. Any portion of the fluidic battery conditioning system 18 is the same as in FIG. 2A.

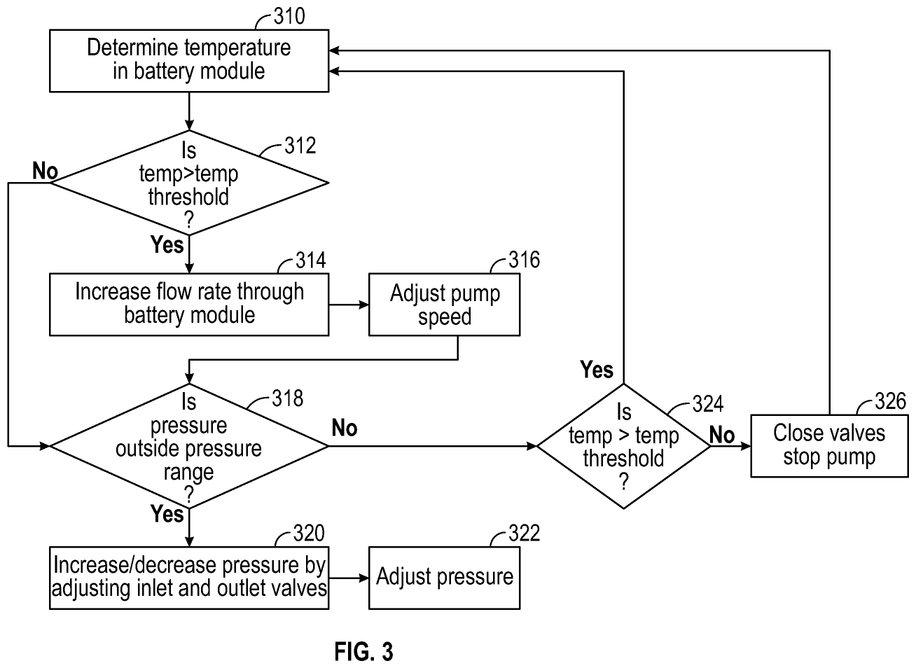

Referring now to FIG. 3, a method for operating the system is set forth. In step 310, the temperature in the battery module is determined based upon the temperature sensor 70 illustrated in FIGS. 2A, 2B. The temperature signal from the temperature sensor 70 is communicated to the battery management system 22 that determines the temperature within the battery module. If the temperature in the battery module is greater than a temperature threshold in step 312, step 314 controls the increase in the flow rate through the battery module in step 314 by adjusting the speed of the inlet module pump 50 (or pumps 50C-F) in step 316.

After step 312 when the temperature is below the threshold and after step 316, step 318 is performed. If the pressure determined by the battery management system 22 from the pressure sensor 72 (of FIG. 2A) indicates that the pressure of the battery cells is outside of a pressure range, step 320 increases or decreases the pressure within the compressible element by controlling the opening or closing of the inlet valve(s) and or the outlet valve(s). Ultimately the valves 52, 54 are controlled by the battery management system 22 in response to the feedback from the pressure sensor 72 which are indicative of the pressure in the battery module 30.

After step 318 indicates that the pressure is not outside the pressure range, step 324 determines whether the temperature is greater than the temperature threshold. If the temperature is not greater than the temperature threshold, the inlet valves and the outlet valve are closed to maintain the pressure in the battery module because cooling is no longer required. The inlet valve 52 and the outlet valve 54 are closed and the inlet module pump is stopped in step 326. In step 324 when the temperature is greater than the temperature threshold step 310 is repeated. Step 310 is also repeated after step 326 so that the battery management system continually monitors the battery modules 30.

Thus, the feedback from the battery management system 22 can independently increase or decrease the pressure and flow rate of the battery module.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,”“an,” and “the” may be intended to include the plural forms as well, unless the context clearly indicates otherwise. The terms “comprises,”“comprising,”“including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,”“engaged to,”“connected to,” or “coupled to” another element or layer, it may be directly on, engaged, connected or coupled to the other element or layer, or intervening elements or layers may be present. In contrast, when an element is referred to as being “directly on,”“directly engaged to,”“directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system comprising:
a battery module having a plurality of walls, said plurality of walls comprising a first end wall spaced apart from a second end wall, said first end wall comprising a fluid inlet and the second end wall comprising a fluid outlet;
a plurality of battery cells disposed between the first end wall and the second end wall, a fluid path is disposed between the plurality of battery cells and the plurality of walls;
an inlet module pump;
an inlet valve in fluid communication with the inlet module pump communicating dielectric fluid into the battery module within the fluid path between the battery cells and the plurality of walls;
an outlet valve in fluid communication with the outlet;
a pressure sensor generating a pressure signal indicative of the pressure within the battery module;
a temperature sensor generating a temperature signal indicative of the temperature within the battery module; and
a controller coupled to the inlet module pump, the inlet valve and the outlet valve, said controller independently controlling a flow rate into the battery module and the pressure within the battery module, said controller controlling the inlet module pump to control the flow rate based on the temperature signal and the inlet valve and the outlet valve to control the pressure based on the pressure signal.

2. The system of claim 1 wherein the fluid path comprises a first fluid path and a second fluid path.

3. The system of claim 2 further comprising a first baffle on an inlet side of the battery module arresting fluid flow in the first fluid path and the second fluid path toward the outlet.

4. The system of claim 3 wherein the first baffle comprises openings for obtaining a predetermined pressure within the battery module.

5. The system of claim 3 further comprising a second baffle disposed on an outlet side of the battery module arresting fluid flow in the first fluid path and the second fluid path toward the outlet.

6. The system of claim 5 wherein the second baffle comprises openings for obtaining a predetermined pressure within the battery module.

7. The system of claim 1 wherein the pressure sensor is disposed in the fluid path and the pressure signal corresponding to a pressure within the fluid path.

8. The system of claim 1 wherein the inlet module pump comprises a constant flow rate pump and a differential flow rate pump, said differential flow rate pump selectively controlled by the controller.

9. The system of claim 1 wherein the fluid outlet is fluidically coupled to a heat exchanger.

10. The system of claim 9 further comprising an expansion element disposed between the outlet valve and the heat exchanger.

11. The system of claim 1 wherein the plurality of battery cells comprises spacers therebetween.

12. A method of controlling a battery module having a plurality of walls, said plurality of walls comprising a first end wall having an inlet spaced apart from a second end wall having an outlet, said battery module comprising a plurality of battery cells disposed between the first end wall and the second end wall, said method comprising
communicating dielectric fluid into fluid paths between the battery cells and module wall from outside the battery module with an inlet module pump through an inlet valve;
communicating the dielectric fluid from the battery module through an outlet valve;
controlling a pressure within the battery module based on a pressure signal from within the battery module by controlling the inlet valve and the fluid outlet valve; and
controlling a temperature within the battery module by controlling a flow rate through the battery module by controlling the inlet module pump.

13. The method of claim 12 further comprising generating the pressure signal from a pressure sensor disposed within one of the fluid paths.

14. The method of claim 12 further comprising arresting flow of dielectric fluid from the inlet toward the outlet by using a first baffle.

15. The method of claim 14 further comprising sizing openings in the first baffle to obtain a predetermined module pressure.

16. The method of claim 14 further comprising arresting flow of dielectric fluid from the inlet toward the outlet by using a second baffle.

17. The method of claim 16 further comprising sizing openings in the first baffle to obtain a predetermined module pressure.

18. The method of claim 12 wherein controlling the pressure comprises controlling the pressure comprises maintaining the pressure by closing the inlet valve and the outlet valve and stopping the inlet module pump.

19. The method of claim 12 further comprising communicating dielectric fluid to an expansion element after the outlet valve.

20. The method of claim 19 further comprising communicating the dielectric fluid to a heat exchanger after the expansion element.
